(19) United States
(12) Patent Application Publication
(10) Pub. No.: US 2006/0252848 A1
(43) Pub. Date: Nov. 9, 2006

(54) Gel-like material in a planar form for the treatment of ambient air

(76) Inventor: Bruno Guillaume, Talence (FR)

Correspondence Address: FOLEY AND LARDNER LLP;SUITE 500, 3000 K STREET NW, WASHINGTON, DC, 20007, US

(21) Appl. No.: 10/567,063

(22) PCT Filed: Jul. 29, 2004
(86) PCT No.: PCT/EP04/08485

§ 371 Date: Mar. 3, 2006

(30) Foreign Application Priority Data
Aug. 4, 2003 (DE) 103 35 938.9

(51) Int. Cl. C09D 5/16

(52) U.S. Cl. 523/122

(57) ABSTRACT

The invention relates to a gel-like material in a planar form for treating ambient air. Said gel-like material contains a matrix comprising crosslinked polymers which are provided with hydrophilic groups and to which volatile active substances are adsorbed. The matrix forms a spongy structure along with said volatile active substances, from which the active substances are slowly and steadily released so as to react with and eliminate malodorous or harmful substances contained in the air. The polymer matrix comprises at least two different polymers which form an interpenetrating network, preferably after being crosslinked.

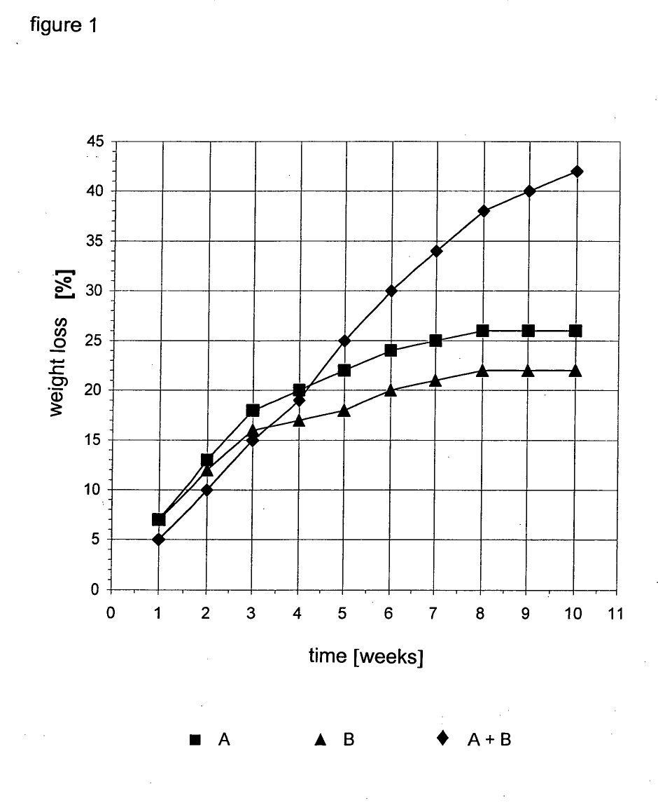

The invention relates to a gel-like material for treatment of ambient air containing a polymer matrix to which volatile active agents are adsorbed, which can be released and volatilize, and thereafter react with and eliminate malodorous or harmful substances in the air.

Various methods are used in practice for the removal or reduction of malodorous substances in the air by means of gas scrubbing. Some of these methods take advantage of the ability of solid substances with a large surface area to adsorb gaseous substances and thus bind them over a prolonged period. For example, mineral carrier materials, paper webs and active charcoal are used as filter inserts in order to remove volatile impurities from streams of air and exhaust air. Another principle consists in impregnating powder, absorbent papers and polymers or highly porous clay granules with active agents that react with malodorous substances or can mask these. They slowly release these active agents again and can thus develop their effect when contaminated air passes over or through them.

WO-A 01/78794 describes an anhydrous gel element for perfuming or deodorizing air which element is formed by cross-linking a functionalized liquid polymer, preferably a maleinized polybutadiene, with a cross-linking agent in the presence of a perfume or a deodorizing base, which can be released from the gel. U.S. Pat. No. 5,569,683 describes a gel which contains a polymer matrix from a cross-linked acrylate polymer and a perfume which can be released from the matrix.

It has turned out, however, that the described gel-like masses are not capable to release the active agents slowly and steadily over a considerably long time.

The object of the present invention is to provide a gel-like mass that can be manufactured simply and contains adsorbed active agents, which is capable of releasing these active agents slowly and steadily over a considerably long time.

This object can be achieved by a gel-like mass containing a matrix from cross-linked polymers bearing hydrophilic groups to which 10 to 90% by weight, with reference to the mass, of volatile active agents are adsorbed which together with the matrix form a spongy structure, from which the active agents can be released to the ambient air and volatilize, wherein the polymer matrix contains at least two different polymers A, B . . . .

As cross-linked polymers two different classes of polymers are suited, namely cross-linked (meth-)acrylate polymers Y and especially cross-linked maleinized or epoxidized polymers X.

Preferred cross-linked (meth-)acrylate polymers Y are prepared by copolymerization of mono-functional (meth-)acrylate monomers having a molecular weight of from 50 to 900 and poly-functional (meth-)acrylate monomers with 2 to 6, preferably 2 or 3 polymerizable double bonds as cross-linking agents, wherein the molar ratio of mono-functional to poly-functional monomers is preferably 20:1 to 1:1, especially 8:1 to 1:1. It is essential that the cross-linked polymer contains hydrophilic groups, for example HO—, —CH2—CH2-O—, H2N—, —COO— or CONH— groups. Such cross-linked polymers are for example described in U.S. Pat. No. 5,569,683.

Suitable mono-functional monomers are for example hydroxyethylacrylate, acrylamide, glycerol monoethyl acrylate, poly(propyleneoxide)(ethylene oxide) monomethyl acrylate (50 POEP 800 B Blemmer), polyethyleneoxide tetrahydrofurane monomethyl acrylate (700 PEP 350 B Blemmer), both made by Nippon Oil and Fats.

Suitable poly-functional monomers are polyethylene glycol-400-dimethacrylate, made by Röhm GmbH, ethylene glycol dimethacrylate, diethylene glycol dimethacrylate and N,N′-methylene bis-acrylamide, made by Biorad. The cross-linked (meth-)acrylate polymers are made by copolymerization of the monomers, the polymerization being initiated by addition of a radical initiator, e.g. hydrogen peroxide and by supply of energy, for example by irradiation with ultraviolet light or by heating.

The polymerization can be carried out in the presence of solid adsorption additives, e.g. of silica gel, zinc oxide, or silicates, and especially in the presence of at least 0,01% by weight of water and/or of other swelling liquids, like alcohols, glycols, paraffin oil and polyalkylene oxide, as well as in the presence of the volatile active agents, resulting in a preferably open-cell spongy structure.

Another preferred polymer class X are cross-linked reaction products of a polymer bearing hydrophilic groups with a cross-linking agent. Suitable polymers bearing hydrophilic groups are maleinized or epoxidized polymers, for example reaction products of polydienes having a molecular weight of between 400 and 10,000, for example polybutadiene, polydecadiene and unsaturated fatty acids such as soybean oil, with maleic anhydride, also copolymers of olefins, such as ethylene, with maleic anhydride, as well as epoxidized polybutadiene and polymethyvinyl ether. Carbohydrates, such as cross-linked fructose and starch, may also be used. Preferred cross-linking agents are polyamines having 2 or 3 amino groups, especially polyoxyalkylene polyamines, such as polyoxypropylenediamine and polyoxypropylenetriamine. Beside polyamines, also urea, polyethylene imine, epichlorohydrin, triethylene glycol and pyromellithic acid dianhydride can be used.

Also, zinc oxide, zinc acetate and calcium hydroxide may act as crosslinking agents, the latter probably forming a stable complex with two maleic anhydride groups.

The cross-linked polymers bearing hydrophilic groups are prepared by condensation of the maleinized or epoxidized polymers with the polyamine, preferably in an alcoholic solution, especially in dipropylene glycol, at elevated temperature, preferably between 40° and 60° C. Here, too, the preferred molar ratio of polymer to cross-linking agent is 20:1 to 1:1, especially 8:1 to 1:1. At a low molar ratio close to 1:1, vigorous cross-linking is achieved, which yields relatively tough and compact sponge-like compositions. The condensation is carried out in the presence of additives such as liquids that have a swelling effect and are surface-active, preferably again in the presence of at least 0.01% of water and in the presence of active agents. Particularly effective hydrophilic groups are the —CRH—O— groups from polyoxyalkylene polyamines, and also the maleic anhydride and carboxyl groups or the —NR—CO— groups of the cross-linked maleinized polymers, as well as the epoxide groups or —COH—CNR— groups of the cross-linked epoxidized polymers.

In both cases the cross-linked polymers form, together with the surface-active liquids, a preferably open-cell sponge structure. The cross-linked polymers have a three-dimensional network with pores in which the volatile foreign substances are sucked up and adsorbed so that the polymer swells like a sponge. In the swollen state, the three-dimensional network consists of elementary cells that have a mean volume of 0,1 to 100 μm, preferably of 0,5 to 50 μm.

According to the present invention the polymer matrix contains at least two different polymers A, B. Each of the polymers should be present in the polymer matrix to at least 10% by weight, preferably to more than 20% by weight. Preferably the polymer matrix contains only two different polymers A and B, one of which is more and the other is less compatible with water resp. soluble in water.

In a preferred embodiment of the invention the polymers A, B . . . , after being cross-linked, form an interpenetrating network. Such interpenetrating network can be obtained by mixing and jointly cross-linking the starting materials for the polymers A, B . . . belonging to the same polymer class X or Y and being compatible with each other, or contacting the starting materials for polymer B for a sufficient period of time with an already cross-linked polymer A and having them diffused into it, and subsequently cross-linking polymer B.

An only partly interpenetrating network can be obtained by mixing the starting materials for different polymer classes X and Y and carrying out the cross-linking reaction for each polymer class one after the other, or contacting the starting materials for the polymer B only for a short period of time with an already cross-linked polymer A, so that they can only partly diffuse into it, in which case the polymers A and B belong to the same polymer class.

In a third embodiment of the invention the starting materials for polymer B is contacted with an already cross-linked polymer A and immediately thereafter cross-linked. In this case a polymer matrix is obtained in which the polymers A and B are present in discrete layers, lying side by side.

Depending on the purpose of its application the gel-like mass can contain different active agents in an amount of 10 to 90% by weight, preferably 20 to 80% by weight:
deodorants and fragrances, for example aldehydes, ketones, alcohols, esters, terpenes or natural oily essences, as well as perfumes;
pesticides, like herbicides, insecticides, insect-repellents, fungicides, nematocides or akaricides;
biocides, like phenols, halogen compounds or quaternary ammonium compounds.

The active agents can be incorporated into the gel-like mass either by mixing them together with the starting materials for the polymers and carrying out the cross-linking reaction in their presence, or by impregnating them subsequently into the polymer matrix. The active agents can be hydrophilic as well as hydrophobic.

In an especially preferred embodiment of the invention the gel-like mass contains 0.01 to 90, preferably 0.05 to 60 and especially 0.1 to 10% by weight of water. This aids to the formation of pores during cross-linking of the polymers and ensures that the active agents can penetrate into these pores, are firmly held in the pores and can diffuse steadily out of them. The diffusion rate can be controlled by the amount of water. It is important that the gel-like mass has an optimal surface tension, preferably between 5 and 80 dynes/m, especially between 20 and 50 dynes/cm. The surface tension can be determined by means of a goniometer, measuring the angle under which a drop is situated on the surface, as described in an article by Y. C. Ko in Journal of Colloid and Interface Science 1981, 82, pages 25 to 37. The optimal surface tension can be adjusted by a suitable combination of polymer, active agent and the amount of added water; it can be established by simple preliminary tests. The lower the surface tension is, the better and more uniformly can the water be absorbed in the polymer matrix.

Beside the active agents and water, the gel-like mass can contain flame retardants, such as bromine compounds, sugar and azodicarbonamide; also solvents, like alcohols, especially dipropylene glycol; means for preventing caking, for example sawdust; as well as sublimation assistants that accelerate the release of the active agents.

A typical composition of the starting materials for the production of the preferred gel-like mass is as follows:

| | |
|---|---|
| Maleinized resp. epoxidized polymer: | 10 to 30% by weight |
| Cross-linking agent: | 0.2 to 10% by weight |
| Water: | 0.1 to 60% by weight |
| Flame retardant: | 1 to 20% by weight |
| Active agent: | Remainder |

The gel-like mass can be applied in the form of crumbs, shavings, granules or spheres, but preferably in planar form as strips or boards having a thickness of 2 to 50 mm. Such strips or boards can be placed on nets or lattices.

In a special embodiment the gel-like mass is present in the form of a thin layer applied onto a carrier material or encased in a carrier material, thus forming a planar sheet. The carrier can be a fiber fleece or a fiber fabric, which both can be coated with a plastic coating. Suitable materials for the carrier are fleeces and fabrics based on natural fibers, like cellulose, cotton or linen fibers, or synthetic fibers, like polyamide or polyester fibers. Suitable carriers are for example the cellulose fiber fleece PGI of Nordlys WDS; the cotton fabric 4110 of Subrenat; further a fiber fleece of Danisco which is coated with a 20 μm thick polyoxypropylene film and a 50 μm thick polyethylene film; and the textile fabric K 286 S 434 of Alsthom. Porous fiber fleeces absorb the gel-like mass so that the fleece becomes impregnated with the gel-like mass. In the case of plastic coated fabrics the gel-like mass is situated as a layer upon the carrier, so that the active agents can diffuse through the plastic coating. By means of such carrier the gel-like mass can be mechanically stabilized in a very thin form which supports the release of the active agents. The carrier together with the gel-like mass form a thin sheet which is preferably 0.01 to 5 mm, especially 0.1 to 2 mm thick. Of course, a plurality of sheets can be stacked, for example to a thickness of up to 50 mm. The sheets resp. stacks can be rolled together, and the individual layers can be separated by flexible nets or lattices, having a distance of 1 to 100 mm, especially 2 to 20 mm from each other. Such rolls can be introduced into sleeves or hollow columns, in which an air stream can be passed parallel to the longitudinal direction of the sleeve or column along the surface of the rolled sheets, so that it can get into a very intimate contact with the gel-like mass and release the active agents.

The sleeves or columns can have on their surface a plurality of holes through which an air stream can be passed perpendicular to the longitudinal direction of the sleeve resp. column. Sleeves can be introduced transverse into exhaust channels or chimneys. Columns which are preferable vertically standing can be installed in closed rooms at especially highly malodorous areas.

For manufacturing the thin sheets first the starting material for polymer A is applied onto the carrier which can be in the form of a conveyor belt guided on two rolls, thereafter cross-linked and calibrated to the desired thickness, for example by a wiper. Then the starting material for polymer B is applied and cross-linked. Depending on the holding time between application and cross-linking a fully interpenetrated network, a partly interpenetrated network or discrete layers of cross-linked polymer A and cross-linked polymer B are obtained. The active agents can be added together with the starting materials for the polymers, however, it is also possible to apply them into or onto the carrier material, from where they can diffuse into the polymer matrix.

In a special embodiment of the invention ultrafine particles of semiconductor compounds are applied to the surface of the thin sheets, for example oxides, sulfides and selenides of zinc and cadmium, preferably zinc oxide. This can be performed by spraying an aqueous suspension onto the surface of the gel-like mass, subsequent to the cross-linking reaction, for example in an amount of 0.01 to 1 g/cm². Particle sizes of 1 to 100 nm, preferably 5 to 60 nm are preferred. Such ultrafine semiconductor particles aid to the release of the active agents, but above all they can react with the malodorous substances and eliminate them from the ambient air.

The active agents are slowly and steadily released from the gel-like mass according to this invention. It is of advantage that the gel-like mass keeps its activity for at least three days, preferably for at least one week and especially for one to six months.

Preferably the gel-like mass is used for removing resp. masking malodorous substances in the air by releasing and evaporating the above described deodorants and fragrances. The released active agent can react with the malodorous substances in the gaseous phase and thus remove the malodorous substances from the air or reduce them. Beside actual chemical reactions, for example between hydrogen sulfide or ammonia and aldehydes, bonding may also take place through electrostatic or van der Waals forces, as the result of which the ability to perceive odors is at least reduced. Furthermore, the active agents can also mask the malodors and/or as specific perfume composition cover the malodor and effect aromatization.

The following practical applications are possible:

In animal breeding facilities, stables, liquid manure containers and especially in hog feeding facilities, the gel-like mass being laid on lattices or nets in the form of boards, strips or sheets. These can be hung directly from the ceiling; preferably, however, several lattices can be arranged on top of or beside each other on a rack. It is also possible to introduce the above described rolls made from thin sheets into sleeves, through which the contaminated air can stream. The racks resp. sleeves can be installed in a ventilation box that can be placed in the room or in inlet air shafts. In the latter case, the fresh air that is sucked in volatilizes the active agents.

In enclosed spaces, for example in rooms, recreation rooms, halls, kitchens and toilets of hospitals, old people's homes, and especially hotels and restaurants. In these cases, the gel-like mass can again be laid upon lattices or nets or introduced in a rack in the form of strips, boards or sheets, or it can be introduced into sleeves in the form of rolls. These can be installed in an air-conditioning shaft or in a ventilation box. Furthermore, it is possible to introduce the gel-like mass into columns in which an air stream is generated by means of a fan which releases the active agents. Such columns can be installed in enclosed spaces at especially highly malodorous areas.

In public transport vehicles, for example railroad, tram and underground railroad carriages, buses and seacraft and aircraft. Here, too, the gel-like mass can be placed on nets or lattices and these can be arranged above each other in a rack or introduced into sleeves in the form of rolls which are installed in the vehicle's air shaft.

On industrial sites, the gel-like mass being installed in exhaust air stacks or in air inlet openings or in the aeration equipment for process air. Where greater contamination is to be expected (for example in vulcanization plants) or where the exhaust air is at a high temperature, which could damage the polymer matrix, the active agent can be blown into the room or sucked in under vacuum through a unit installed at the side, where it can mix with the exhaust air and react with the malodorous substances.

In large-scale plants, for example in sedimentation tanks, wastewater treatment plants, composting facilities, landfills, waste sorting facilities, but also in entire industrial facility complexes in which malodorous solid and liquid substances are stored open-air. Here, preferably, the gel-like mass is introduced in the form of strips, boards or stacks of thin sheets into lattices which are installed between parallel boards. These boards can be fixed on posts which can be erected at suited places of the open-air plant. Air is passed through the gap between the boards which releases the active agents. This is performed preferably by natural wind which eventually can be intensified by a fan.

Another application of the gel-like mass according to this invention consist in loading it with the above mentioned pesticides. In the form of crumbs, shavings or granules they can be spread directly onto the soil or the plants. Boards and strips can be placed on lattices or nets and laid onto racks, and thin sheets can be introduced into sleeves. The racks resp. sleeves can be placed on fields or in vineyards hung on wires.

Finally, the gel-like mass can be loaded with the above described biocides which can react with harmful microorganisms in the air and exterminate them.

A further object of the invention is a gel-like mass in the form of an extremely thin sheet which contains a matrix from cross-linked polymers bearing hydrophilic groups, the matrix having adsorbed 10 to 90% by weight, with reference to the mass, of volatile active agents which form together with the matrix a sponge-like structure from which the active agents can be released to the ambient air and volatilize. The mass is characterized in that is applied onto a carrier material or encased in a carrier material, forming together with the carrier a sheet having a thickness of 0.01 to 2 mm, preferably of 0.1 to 1.8 mm.

WO-A 98/07454 describes a thin polymer film based on an acrylate copolymer which acts as a deodorant. However, the deodorant is copolymerized into the polymer and cannot be released therefrom. Insofar, the above described object of the invention is new.

The just described gel-like mass preferably contains 0.01 to 90%, especially 0.05 to 60% by weight, of water. The thin sheet again can be stacked in a plurality of layers and rolled together.

Such extremely thin sheets, especially when they contain water, are highly efficient even if the polymer matrix contains only one single cross-linked polymer bearing hydrophilic groups. It seems that this is due to the relatively large surface of the sheets, especially when they are rolled together, leaving gaps between them.

### EXAMPLE 1a

Solution A: 2 g acrylamide was mixed with 0.5 g N,N′-methylene-bis-acrylamide dissolved in 7.5 g water, 0.1 ml 30% hydrogen peroxide and 5 g of a liquid perfume (vanillin). The mixture was degassed in a ultrasonic bath under slight vacuum and stirred for 5 min at 5° C. in a colloidal mill at 300 rpm.

Solution B: 2 g acrylamide, 0.5 g polyethylene glycol-(400)-dimethacrylate dissolved in 7.5 g water, 0.1 ml 30% hydrogen peroxide and 3 g of the perfume were mixed as described, degassed and stirred.

Step 1: Solution A was slowly and steadily applied onto a conveyor belt made from a cellulose fiber fleece (PGI of Nordlys, WDS) and guided over two rolls with a velocity of 0.1 cm/sec, then it was polymerized by using a UV-lamp (40 mW/cm² at a distance of 5 cm from the carrier) and calibrated to a thickness of 1 mm by using a flexible wiper.

Step 2: Solution B was applied onto the conveyor belt. After a waiting time of 30 min, during which solution B diffused into the already formed polymer A, solution B was polymerized as describes. In total, the conveyor belt with the polymerizing solutions passed the UV-lamps five times. The formed polymer B was somewhat less water-compatible than polymer A; the polymer matrix contained the polymers A and B in the form of an interpenetrating network. It was not possible to separate the polymer matrix into two layers.

A surface tension of 45 dynes/cm was measured on the resulting, a little bit more than 1 mm thick sheet having a size of 22×30 cm. Two layers of the sheet were stacked one over the other and rolled to a four-layered roll, in which the layers had a distance of 5 mm from each other. The roll was stored in a moisture chamber at 25° C. and an air humidity of 50%. The weight loss due to the release and volatilization of the perfume and of water was measured. The weight loss after 10 weeks was steady and amounted to not more than 42%, which means that the efficiency of the gel-like mass lasted for a relative long time.

For comparison the solutions A and B were polymerized separately and the weight loss was measured. The progression of the curve in relation to time was unsteady, after six weeks the weight loss with polymer A was 23% and with polymer B 20%. Thereafter practically no further weight loss occurred, which means that the gel-like mass had lost its efficiency already after six weeks.

The curves are shown in the attached figure.

### EXAMPLE 1b

Example 1a was repeated, however, the waiting time after the application of solution B onto polymer A was only 10 min. In the resulting gel-like mass the polymer matrix was obtained in the form of an only partly interpenetrating network. With a high expenditure of energy two layers with the polymers A and B could be separated.

### EXAMPLE 1c

Example 1a was repeated, but without waiting time the solution B, immediately after having been applied to the polymer A, was cross-linked. In the polymer matrix two polymers A and B were present as discrete layers, which could be separated easily.

### EXAMPLE 2

Example 1 was repeated, however in solution A 4 g polyethylene oxide monomethacrylate (of Nippon Oil and Fat) and 0.5 g polyethyleneglycol-(400)-dimethacylate were used, and in solution B 5 g glycerin monomethacylate (of Nippon Oil and Fat) and 0.5 g polyethyleneglycol-(400)-dimethacrylate. The resulting polymer A is less water-compatible than polymer B. The surface tension of the sheet was 42 dynes/cm, the weight loss after ten weeks was 28%, and the sheet had kept its full efficiency after that time.

### EXAMPLE 3

Solution A: 15 g of epoxidized polybutadiene (Poly bd of Atofina), 3 g polyoxpropylene diamine (Jeffamine D 400 of Huntsman) and 8 g water were mixed with 70 g of a liquid perfume and degassed and stirred as described in Example 1.

Solution B: 20 g fructose (Arabin-2-hexulose of Cerestar) and 1 g pyromellithic acid dianhydide (Allco PDMA of Allco) were mixed with 10 g of a liquid insecticide (Azadirachtin A of Andermatt) and 0.3 g of water, degassed and stirred.

The steps 1 and 2 of the cross-linking reaction were carried out as in Example 1, but using a 80° C. hot air stream instead of the UV-lamp. The resulting polymer A is not water-soluble, but the polymer B is. The surface tension was 35 dynes/cm, the weight loss after ten weeks was 25%.

Application: Ten layers of the resulting, a little bit more than 1 mm thick sheet were stacked and introduced into a net. Several nets were hung onto the wire construction of a vineyard, where they displayed their insecticide efficiency for more than three months.

### EXAMPLE 4

Solution A: 16 g of maleinized polyvinylmethyl ether (Gantrez SP 215 of ISP), 0.5 g polypropylene diamine, 0.5 g triethyleneglycol diamine, 70 g of a liquid perfume, 1 g maleinized soyabean oil and 0.3 g water were mixed. The mixture was degassed and stirred.

Solution B: 0.5 g polyoxypropylene diamine, 0.5 g triethyleneglycol diamine, 30 g perfume, 40 g maleinized soyabean oil and 1 g pyromellithic acid dianhydride were mixed, degassed and stirred.

Polymer A is water-soluble, polymer B is water-insoluble. The weight loss after 10 weeks was 20%. This low value is probably due to the low water content of the gel-like mass.

### EXAMPLE 5

Example 1 was repeated, however, the liquid perfume was not added to the starting substances of the polymers A and B, but it was applied onto the fiber fleece and sucked by it. During the application of the starting materials for the polymers and during the cross-linking reaction the perfume diffused into the gel-like mass.

### EXAMPLE 6

Example 1 was repeated, however, 0.05% by weight of zinc oxide were added to the solution A. This acts as an additional cross-linking agent, furthermore, zinc and cadmium compounds are in the position to bind malodorous substances in the air, for example sulfur compounds.

### EXAMPLE 7

Solution a: 10 g maleinized polybutadiene (reaction product of liquid polybutadiene and maleic acid anhydride (Lithene of Revertex)) were mixed with 40 g dipropylene glycol at 50° C. 3 g polyoxypropylenen diamine (molecular weight 400) were mixed at room temperature with 45 g dipropylene glycol. The two mixtures were stirred together in a flat vessel at 20° C.

Solution B: 16 g of the ethyl halfester of the polycarbonic acid from maleinized vinylmethyl ether (Gantrez SP 215 of ISP), 0.5 g polyoxypropylene diamine, 0.5 g polyoxypropylene triamine (molar ration 1:1) and 3 g water were mixed together with 70 g of a 50% solution of an active agent (vanillin) in diethylene glycol at 20° C.

Cross-linking: Solutions A and B were mixed together and stirred for 40 min at 80° C. The resulting gel-like mass contained as polymer matrix a partly interpenetrating network of the polymers A and B.

Application: The gel-like mass was cut into boards having a thickness of 2 cm and a width of 20 cm, and the boards were laid upon metal nets. The nets were introduced between two parallel plastic boards having a size of 50×50 cm and a distance of 10 cm from each other. 16 boards were laid down on the sloping flange of a 100 m² large wastewater treatment plant, where they displayed their efficiency for several weeks.

1. Gel-like mass for the treatment of ambient air, containing a matrix from cross-linked polymers bearing hydrophilic groups, namely
a. X) reaction products of a polymer bearing hydrophilic groups and having a molecular weight of more than 400, selected from maleinized or epoxidized polymers or carbohydrates, with a cross-linking agent, selected from polyamines with 2 or 3 amino groups, urea, polyethylene imine, epichlorhydrin, triethyleneglycol, pyromellithic acid anhydride, zinc oxide, zinc acetate or calcium hydroxide, or
Y) copolymers of a monofunctional (meth-)acrylate monomer having a molecular weight of 50 to 1000 and a polyfunctional (meth-)acrylate monomer as cross-linking agent,
to which 10 to 90%, with reference to the mass, of volatile active agents are adsorbed, which together with the matrix form a sponge-like structure, from which the active agents can be released to the ambient air and volatilize, characterized in that the polymer matrix contains at least two different polymers A, B, . . . .

2. Gel-like mass according to claim 1, characterized in that the polymers A, B, . . . after cross-linking form an interpenetrating network in the polymer matrix.

3. Gel-like mass according to claim 1, characterized in that the polymers A, B, . . . after cross-linking form a partly interpenetrating network in the polymer matrix.

4. Gel-like mass according to claim 1, characterized in that the polymers A, B, . . . after cross-linking are present in the polymer matrix as discrete layers lying side by side.

5. Gel-like mass according to claim 1, characterized in that the polymer matrix consists of two different polymers A and B, of which one is more and the other is less water-compatible.

6. Gel-like mass according to claim 1, characterized in that the polymer matrix contains at least 10% by weight of each of the polymers A, B, . . . .

7. Gel-like mass according to claim 1, characterized in that the cross-linking agent is a polyamine.

8. Gel-like mass according to claim 1, characterized in that the polymer of polymer class X is a maleinized or epoxidized polydiolefine, preferably polybutadiene or polydecadiene.

9. Gel-like mass according to claim 8, characterized in that the maleinized polymer is a reaction product of a liquid polybutadiene and maleic acid anhydride.

10. Gel-like mass according to claim 7, characterized in that the polyamine is polyoxypropylene diamine or polyoxypropylene triamine.

11. Gel-like mass according to claim 1, characterized in that the cross-linked polymers X contains hydrophilic —CHR—O— and/or —NR—CO— groups.

12. Gel-like mass according to claim 13, characterized in that the monofunctional monomer contains hydrophilic HO—, —CH2—CH2-O—, H₂N— or CONH— groups.

13. Gel-like mass according to claim 1; characterized in that the active agents are aldehydes, ketones, alcohols, esters, terpenes or natural oily essences.

14. Gel-like mass according to claim 1, characterized in that the active agents are herbicides, insecticides, insect-repellents, fungicides, nematocides or akaricides.

15. Gel-like mass according to claim 1, characterized in that the active agents are biocides, like phenolic compounds, halogen compounds or quaternary ammonium compounds.

16. Gel-like mass according to claim 1, characterized that the polymer matrix contains 0.01 to 90% by weight of water.

17. Gel-like mass according to claim 1, characterized in that the polymer matrix contains flame retardant agents, like bromine compounds, sugar, azodicarbonamide; solvents, like alcohols; means for preventing caking, like saw dust; and sublimation assistants which accelerate the release of the active agents.

18. Gel-like mass according to claim 1, characterized by a surface tension of between 5 and 80 dynes/cm.

19. Gel-like mass according to claim 1, characterized in that the polymer matrix contains microscopic voids having a pore size of 0.1 to 100 μm, in which the active agents are adsorbed.

20. Gel-like mass according to claim 1, characterized in that it is applied to a carrier material or encased in a carrier material, so that it forms together with the carrier material a flat sheet.

21. Gel-like mass according to claim 20, characterized in that the carrier material is a fiber fleece or a fiber fabric which may be coated with a plastic material.

22. Gel-like mass according to claim 21, characterized in that the fibers are cellulose, cotton, linen, a polyamide or a polyester.

23. Gel-like mass according to claim 20, characterized that the flat sheet is 0.01 to 5 mm thick.

24. Gel-like mass which is applied to a carrier material according to claim 20 and has the form of a sheet, characterized in that the sheet is rolled together, the individual layers having a distance of 1 to 100 mm from each other.

25. Gel-like mass according to claim 1, characterized in that it is in the form of crumbs, shavings, granules or spheres.

26. Gel-like mass according to claim 1, characterized in that it is in the form of strips or boards having a thickness of 2 to 50 mm and being laid upon nets or lattices.

27. Gel-like mass according to claim 1, characterized in that the active agents are released slowly and steadily for a period of at least three days.

28. The use of the gel-like mass according to claim 1 for removing or masking malodorous substances in the air, characterized in that the adsorbed active agents aldehydes, ketones, alcohols, esters, terpenes or natural oily essences are slowly and steadily released and volatilize, and then react with the malodorous substances or mask them.

29. The use as claimed in claim 28 for deodorizing animal breeding facilities, stables and liquid manure containers, especially pig breeding facilities.

30. The use as claimed in claim 28 for deodorizing rooms in buildings, especially in hotels and restaurants.

31. The use as claimed in claim 28 for deodorizing public means of transport.

32. The use as claimed in claim 28 for deodorizing large-scale plants in which malodorous solid or liquid substances are stored open-air.

33. The use of the gel-like mass according to claim 1 as pesticides, characterized in that the adsorbed active agents herbicides, insecticides, insect-repellents, fungicides, nematocides or akaricides are slowly and steadily released and display their efficiency against pests and harmful substances.

34. The use of the gel-like mass according to claim 1 for the extermination of harmful microorganisms, characterized in that the adsorbed active agents biocides, like phenolic compounds, halogen compounds or quaternary ammonium compounds are slowly and steadily released and react with the microorganisms and exterminate them.

35. Gel-like mass according to claim 1 in the form of a thin sheet, characterized in that the surface of the gel-like mass is coated with 0.01 to 1 g per cm² of ultrafine particles of an oxide, a sulfide or a selenide of zinc or cadmium.
